(19) United States
(12) Patent Application Publication
(10) Pub. No.: US 2016/0305031 A1
(43) Pub. Date: Oct. 20, 2016

(54) APARATUS AND METHOD FOR DECOMPOSING NITROGEN OXIDE

(71) Applicant: GENERAL ELECTRIC COMPANY, Schenectady, NY (US)

(72) Inventors: Shizhong Wang, Shanghai (CN); Qunjian Huang, Shanghai (CN); Hai Yang, Shanghai (CN); Qijia Fu, Shanghai (CN); Andrew Philip Shapiro, Schenectady, NY (US); Hua Zhang, Greenville, SC (US)

(21) Appl. No.: 15/102,903

(22) PCT Filed: Nov. 20, 2014
(86) PCT No.: PCT/US2014/066636

§ 371 Date: Jun. 9, 2016

(30) Foreign Application Priority Data
Dec. 13, 2013 (CN) 201310687068.7

(51) Int. Cl. C25B 9/06; C25B 9/18; B01D 53/32; C25B 1/00; C25B 1/02

(52) U.S. Cl. CPC C25B 9/06; C25B 1/00; C25B 1/02; B01D 53/326; C25B 9/18; B01D 2259/818

(57) ABSTRACT

A apparatus includes a first stack having: a porous metallic current collector; a first electrode layer on the porous metallic current collector; a second electrode layer; a first electrolyte layer between the first electrode layer and the second electrode layer; a third electrode layer on the porous metallic current collector, the third electrode layer sandwiching the porous metallic current collector therebetween with the first electrode layer; a fourth electrode layer; and a second electrolyte layer between the third and the fourth electrode layers. A method includes: providing (he apparatus; applying a first electric field between the first electrode layer and the second electrode layer; applying a second electric field between the third and the fourth electrode layers; and introducing nitrogen oxide to the apparatus to be decomposed into nitrogen and oxygen in the apparatus.

### BACKGROUND

The invention relates generally to apparatuses and methods for decomposing nitrogen oxide.

Nitrogen oxide (NOx, including NO and/or NO₂) is undesirable for the environment and has to be controlled. Some approaches have been proposed to decompose nitrogen oxide into nitrogen and oxygen. However, these approaches use hazardous compound such as ammonia or rigid ceramic materials, and/or cause secondary pollution by producing ammonium sulfate, besides being complex and expensive.

Therefore, while some of the proposed approaches have general use in various industries, it is desirable to provide new apparatuses and methods for decomposing nitrogen oxide.

### BRIEF DESCRIPTION

In one aspect, the invention relates to an apparatus including a first stack having: a porous metallic current collector; a first electrode layer on the porous metallic current collector; a second electrode layer; a first electrolyte layer between the first electrode layer and the second electrode layer; a third electrode layer on the porous metallic current collector, the third electrode layer sandwiching the porous metallic current collector therebetween with the first electrode layer; a fourth electrode layer; and a second electrolyte layer between the third and the fourth electrode layers.

In another aspect, the invention relates to a method comprising: providing an apparatus described in the paragraph above; applying a first electric field between the first electrode layer and the second electrode layer; applying a second electric field between the third and the fourth electrode layers; and introducing nitrogen oxide to the apparatus to be decomposed into nitrogen and oxygen in the apparatus.

### DRAWINGS

These and other features, aspects, and advantages of the present invention will become better understood when the following detailed description is read with reference to the accompanying drawings, wherein:

FIG. 1 illustrates a schematic cross sectional view of an apparatus according to some embodiments of the invention;

FIG. 2 shows a schematic cross sectional view of an apparatus according to other embodiments of the invention;

FIG. 3 illustrates the temperature, the temperature change speed and the time in the process for sintering the composition of table 1 and the nickel foam in example 2;

FIG. 4 shows the temperature, the temperature change speed and the time in the process for sintering the composition of tables 1 and 2, and the nickel foam in example 2;

FIG. 5 shows NO (80 ml/min 400 ppm NO balanced with He) decomposition/conversion percentage of the reactor using NiO-SSZ as the cathode layer at 600° C. and 700° C. as a function of the electric current, respectively;

FIG. 6 illustrates NO conversion rates of NO (80 ml/min 400 ppm NO balanced with fie) under 50 mA at some typical temperatures in reactors using NiO-SSZ, LSM-SSZ, and LSNM-SSZ as cathode layers; and

FIG. 7 illustrates NO conversion rate of 20 ppm NO and 2000 ppm O₂ as a function of the electric current in the reactor using LSNM-SSZ as a cathode layer.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. The use of “including”, “comprising” or ing” and variations thereof herein are meant to encompass the items listed thereafter and equivalents thereof as well as additional items.

Approximating language, as used herein throughout the specification and claims, may be applied to modify any quantitative representation that could permissibly vary without resulting in a change in the basic function to which it is related. Accordingly, a value modified by a term or terms, such as “about” is not to be limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the specification and the claims, the singular forms “a”, “an” and “the” include plural referents unless the context clearly dictates otherwise. Moreover, the suffix “(s)” as used herein is usually intended to include both the singular and the plural of the term that it modifies, thereby including one or more of that term.

As used herein, the term “or” is not meant to be exclusive and refers to at least one of the referenced components (for example, a material) being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can he expected, while in other circumstances, the event or capacity cannot occur. This distinction is captured by the terms “may” and “may be”.

Reference throughout the specification to “some embodiments”, “other embodiments”, and so forth, means that a particular element (e.g., feature, structure, and/or characteristic) described in connection with the invention is included in at least one embodiment described herein, and may or may not be present in other embodiments. In addition, it is to be understood that the described inventive features may be combined in any suitable manner in the various embodiments.

Embodiments of the present invention relate to apparatuses and methods for decomposing nitrogen oxide.

As used herein the term “nitrogen oxide” refers to nitrogen monoxide, nitrogen dioxide, or a combination thereof. The nitrogen oxide may be from a variety of sources, such as gas turbines, internal combustion engines, and combustion devices.

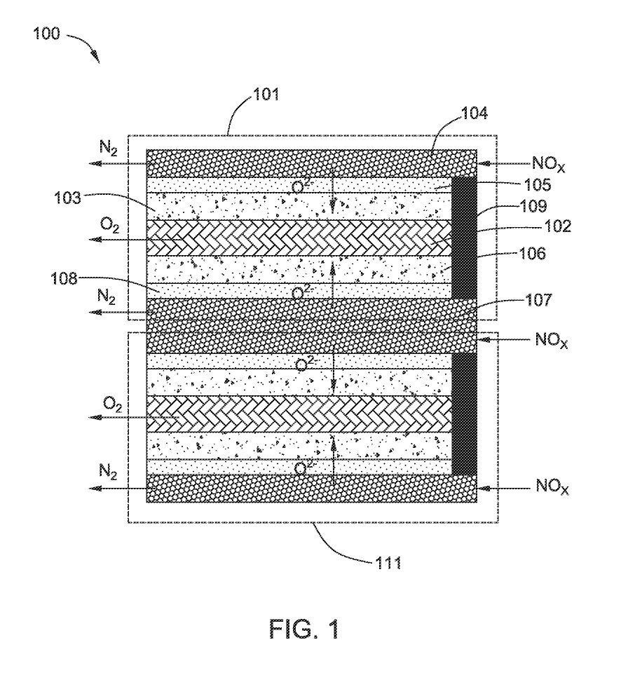

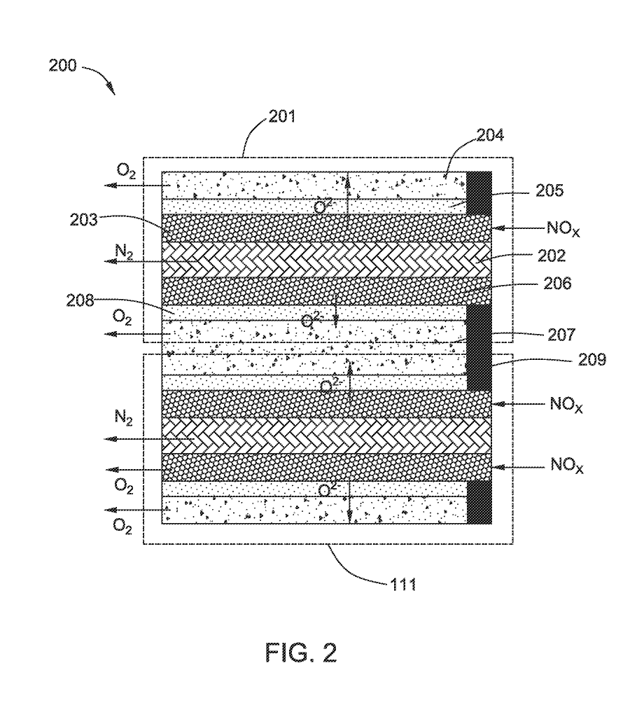

Please refer to FIGS. 1 and 2, an apparatus 100, 200 according to embodiments of the invention includes a first stack 101, 201 having: a porous metallic current collector 102, 202; a first electrode layer 103, 203 on the porous metallic current collector 102, 202; a second electrode layer 104, 204; a first electrolyte layer 105, 205 between the first electrode layer 103, 203 and the second electrode layer 104, 204; a third electrode layer 106, 206 on the porous metallic current collector 102, 202, the third electrode layer 106, 206 sandwiching the porous metallic current collector 102, 202 therebetween with the first electrode layer 103, 203; a fourth electrode layer 107, 207; and a second electrolyte layer 108, 208 between the third and the fourth electrode layers 106, 206, 107, 207.

The porous metallic current collector 102, 202 may be made of any metals or metal alloys and be in any porous forms suitable for use in apparatuses and methods for decomposing/converting nitrogen oxide to nitrogen and oxygen. In some embodiments, the porous metallic current collector 102, 202 is made of nickel. In some embodiments, the porous metallic current collector 102, 202 is in the form of mesh, porous film, foam, or any combination thereof. In some embodiments, the porous metallic current collector 102, 202 is nickel foam. In some embodiments, a porosity of the porous metallic current collector 102, 202 in a range from about 25% to about 99%.

In some embodiments, the porous metallic current collector 102, 202 is mechanical support for the first, the second, the third and the fourth electrode layers 103, 203, 104, 204, 106, 206, 107, 207 and the first and the second electrolyte layers 105, 205, 108, 208.

The porous metallic current collector may be a single layer or has more than one layer. In the embodiments of the porous metallic current collector having more than one layer, different layers may be electrically and/or mechanically connected with each other in suitable ways.

In some embodiments, as is shown in FIG. 1, each of the first and the third electrode layers 103, 106 is an anode layer and each of the second and the fourth layers 102, 104 is a cathode layer.

In other embodiments, as is shown in FIG. 2, each of the first and third electrode layers 203, 206 is a cathode layer and each of the second and fourth electrode layers 202, 204 is an anode layer.

In some embodiments, the first stack 101, 201 includes a blocking layer 109, 209 configured to block nitrogen oxide from entering the anode layers 103. 106, 204, 207, the electrolyte layers 105, 108, 205, 208 and the porous metallic current collector 102. The blocking layer may be made of any material that blocks gas in some embodiments, the blocking layer is a glass layer. In some embodiments, the first stack 101, 201 has other layers (not shown) as is needed for the specific application environment.

The apparatus may include more than one stack, the same as or different from each other. In some embodiments, as is shown in FIGS. 1 and 2, the apparatus 100, 200 includes a second stack 111, 211, in some embodiments, the first and the second stacks 111, 211 connect at the second or the fourth electrode layers thereof. In some embodiment, the connecting second or fourth electrode layers are separate from or integral with each other. In some embodiments, there are other layers (not shown) between adjacent stacks.

Each of the layers may be a single layer or comprise more than one layer depending on the needed flexibility, gas diffusion capability, and porosity. Multiple layers may be the same as or different from each other and connected in suitable ways. In each single layer, the composition may be the same or different through at least one dimension thereof.

The anode layers may be the same as or different from each other. Any of the anode layers may include any material that oxidizes oxygen ions to oxygen and any other materials that can be used in the anode layers. In some embodiments, the anode layer comprises (La_{0.8}Sr_{0.2})_{0.95}MnO₃ (LSM), a combination of platinum and yttria stabilized zirconia, a combination of platinum and Gd addition ceria, or any combination thereof. In sonic embodiments, the anode layer includes materials that catalyze the oxidization of oxygen ions to oxygen. In some embodiments, the anode layer has materials that improve the discharge of oxygen.

The cathode layers may be the same as or different from each other. Any of the cathode layers may include any material that decomposes nitrogen oxide to nitrogen and oxygen and any other materials that can be used in the cathode layers. In some embodiments, the cathode layer has materials that adsorb nitrogen oxide, in some embodiments, the cathode layer includes catalysts catalyzing the decomposition of nitrogen oxide. In some embodiments, the cathode layer comprises catalysts catalyzing the decomposition of nitrogen oxide with little or no impact by the presence of oxygen. The oxygen coexisting the nitrogen oxide may be discharged from the cathode layer.

In some embodiments the cathode layer comprises La_{0.6}Sr_{0.4}Ni_{0.3}Mn_{0.7}O₃ (LSNM), a combination of LSNM and Gd_{0.1}Ce_{0.9}O_{1.95} (GDC), LSNM-Zr_{0.89}Sc_{0.1}Ce_{0.01}O₂₋ₓ(SSZ) (50 wt % ratio), LSNM-NliO-SSZ (40 wt %, 30 wt %, 30 wt. %). NiO-SSZ (50 wt %), a combination of platinum and yttria stabilized zirconia, a combination of platinum and Gd addition ceria, or any combination thereof.

The electrolyte layers may be the same as or different from each other. The electrolyte layers may include any material that has the oxygen ion conductivity and any other suitable material. In some embodiments, the electrolyte layer comprises Gd_{0.1}Ce_{0.9}O_{1.95} (GDC), Zr_{0.89}Sc_{0.1}Ce_{0.01}O₂₋ₓ(SSZ), BaZr_{0.7}Ce_{0.2}Y_{0.1}O₃, or any combination thereof. In some embodiments, the electrolyte layer includes zeolite, alumina, silica, nitriding aluminum, SiC, nickel oxide, iron oxide, copper oxide, a calcium oxide, magnesium oxide, a zinc oxide, aluminum, yttria stabilized zirconia, scandia stabilized zirconia, perovskite oxides, such as samarium or a gadolinium addition ceria, lanthanum strontium calcium manganese, iron oxide, lanthanum silicate, Nd_{9.33}(SiO₄)₆O₂, AlPO₄, B₂O₃, and R₂O₃, (R stands for an alkaline metal), AlPO₄—B₂O₃—R₂O glass which carries out the main component of Na and the K, porous SiO₂—P₂O₅ system glass, Y addition BaZrO₃, Y addition SrZrO₃ and Y addition SrTiO₃, strontium doping lanthanum manganite, a lanthanum strontium cobalt iron oxide (La—Sr—Co—Fe system perovskite type oxide), a La—Sr—Mn—Fe system perovskite type oxide, a Ba—Sr—Mn—Fe system perovskite type oxide, or any combination thereof.

When the first and the second electric fields are respectively applied between the anode layer and the cathode layer, nitrogen oxide is decomposed in the cathode layer in a reaction such as NO+2e→1/2N₂+O^{2'}, nitrogen is discharged from the cathode layer, and the porous metallic current collector, if not being blocked. A porous structure for the cathode layer can increase the active surface area, the reaction rate for NO reduction and the diffusion of nitrogen oxide and nitrogen.

A dense electrolyte layer is preferred for mitigating the mixing of the gases of the cathode layer and the anode layer and reducing the ohmic resistance of the electrolyte layer. Low ohmic resistance is preferred for energy saving in NO reduction process.

Oxygen ions travel from the cathode layer through the electrolyte layer into the anode layer to be oxidized into oxygen in a reaction such as O²⁻−2e→1/2O₂. The produced oxygen is discharged from the anode layer, and the porous metallic current collector, if not being blocked.

In some embodiments, a total reaction in one stack includes: NO=1/2N₂+1/2O₂.

The decomposition of nitrogen oxide may be at any suitable temperature. In some embodiments, the temperature is in a range from about 400° C. to about 800° C.

The stack described herein may be prepared by providing a porous metallic current collector and applying sequentially different layers on both sides thereof, or providing any of other layers and laminating different layers on either/both sides thereof. The layers may be applied/laminated by any suitable means such as dip coating, spray and printing.

The apparatus transmits gases separately in electrode layers and the porous metallic current collector, so there is no need for special design of gas channels. The porous metallic current collector is flexible, cheap and comparatively easy to manufacture.

### EXAMPLES

The following examples are included to provide additional guidance to those of ordinary skill in the art in practicing the claimed invention. These examples do not limit the invention as defined in the appended claims.

### Example 1

### La_{0.6}Sr_{0.4}Ni_{0.3}Mn_{0.7}O₃(LSNM) Synthesis

La₂O₃, SrCO₃, and Mn(AC)₂.4H₂O & NiO were ball milled in Et0H. and calcine at 1300° C. for 8 hours to prepare LSNM. X--ray diffraction (XRD) analyses confirmed that a pure phase of LSNM was obtained.

### Example 2

### Lamination

A slurry with the formula in table I below was prepared, screen printed on Ni foam (95% porosity), and sintered in argon for 6 hours to obtain a first electrode layer on the porous nickel foam. V006 was obtained from Heraeus Materials Technology LLC, 24 Union Hill Road, West Conshohocken, Pa. 19428 USA.

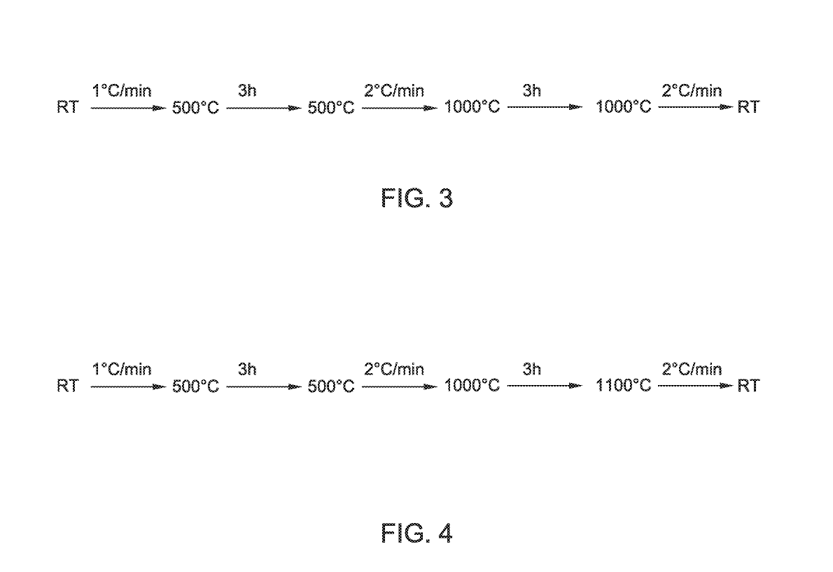

The temperature, the temperature change speed, and time of the sintering are shown in FIG. 3 in which RT stands for the room temperature. Scanning electron microscope (SEM) analysis reveals that a uniform crack-free coating of the first electrode layer was formed on the nickel foam and was ready for cell fabrication, indicating a good compatibility of the first electrode layer with the porous nickel foam.

TABLE 1

| composition | weight |
|---|---|
| V-006 | 0.1 g |
| α-terpineol | 0.4 g |
| LSNM | 0.7 g |
| GDC | 0.3 g |

A slurry with the formula in table 2 below was prepared, screen printed on the first electrode layer, and sintered in Argon for 6 hours to obtain a first electrolyte layer on the first electrode layer. The temperature, the temperature change speed, and tune of the sintering are shown in FIG-. 4. SEM analysis reveals a high density pore free electrode layer was obtained.

TABLE 2

| composition | weight |
|---|---|
| V-006 | 0.1 g |
| α-terpineol | 0.4 g |
| GDC | 0.1 g |

### Example 3

### Decomposition of Nitrogen Oxide

Four 7.5 cm long one-end open (La_{0.8}Sr_{0.2})_{0.95}MnO₁ (LSM) tubes were fabricated by extruding. The outer diameter of each tube was about 1 cm, and the inner diameter was about 0.7 cm. A dense Zr_{0.89}Sc_{0.1}Ce_{0.01}O₂₋ₓ(SSZ) electrolyte film was then coated on each LSM tube and was co-sintered with the LSM tube at 1250° C. La_{0.6}Sr_{0.4}Ni_{0.3}Mn_{0.7}O₃ (LSNM), LSNM-SSZ (50 wt % ratio), LSNM-NiO-SSZ. (40, 30, 30 wt %), and NiO-SSZ (50 wt %) layers were then deposited on SSZ electrolyte film and sintered at around 900-1100° C. to obtain reactors. The active catalyst area of each of La_{0.6}Sr_{0.4}Ni_{0.3}Mn_{0.7}O₃, (LSNM), LSNM-SSZ (50 wt % ratio), LSNM-NiO-SSZ (40 wt %, 30 wt %, 30 wt %), and NiO-SSZ (50 wt %) layers was about 10 cm². A layer of porous platinum paste was applied to each of La_{0.6}Sr_{0.4}Ni_{0.3}Mn_{0.7}O₃ (LSNM), LSNM-SSZ (50 wt % ratio), LSNM-NiO-SSZ (40 wt %, 30 wt %, 30 wt %), and NiO-SSZ (50 wt %) layers to act as a porous metallic current collector.

The microstructures of the reactors were analyzed. As a typical example, SEM images of LSM/SSZ/NiO-SSZ reactor show that three layers could be observed on the cross section of the tube, the LSM layer had a porous structure with low porosity, SSZ had a dense structure, while NiO-SSZ had a porous structure with high porosity.

The reactors were each put inside an alumina tube. The inner diameter of the alumina tube was about 2 cm. Gases containing NO (80 ml/min gas containing 400 ppm NO balanced with He or 200 ml/min gas containing 2.0 ppm NO balanced with He) were fed into the alumina tube passing through the outer surface of the reactor in the temperature range of 600-800° C. Direct current (DC) electric field was applied on the LSM/SSZ/NiO-SSZ reactor with a range about 0-200 mA. The NiO-SSZ layer was assigned as cathode, where electrochemical NO reduction took place. The LSM layer was the anode, where the oxidation of oxygen ions took place. The corresponding voltage between anode and cathode was in the range of 1 1.5 V. Gas chromatography equipped with a PQ column and a RAE7800 gas sensor were used to detect NC) and NO2 with an accuracy of I ppm and 0.1 ppm, respectively. Effects of O₂ in the feeding gas on the conversion of NO were tested on typical catalysts by using a gas containing 20 ppm NO and 2000 ppm O₂.

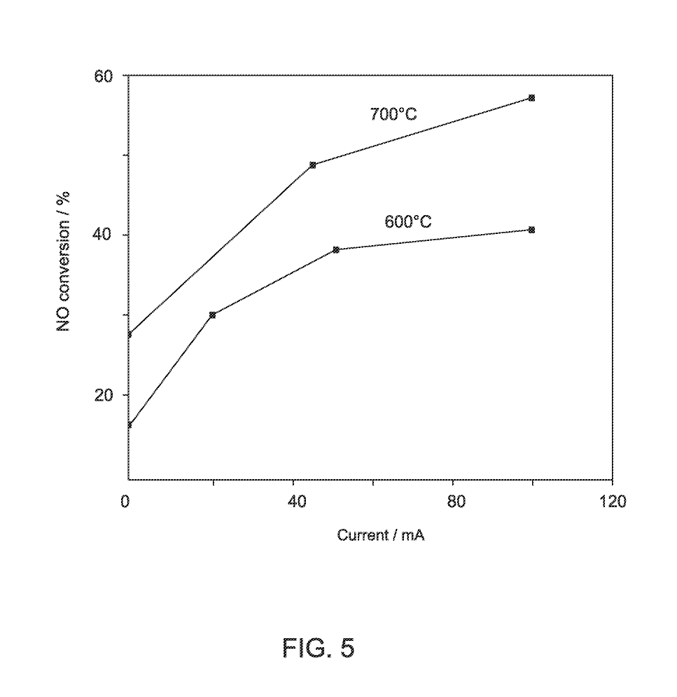

FIG. 5 shows NO conversion percentage of the reactor using NiO-SSZ as the cathode layer at 600° C. and 700° C. (80 ml/min 400 ppm NO balanced with He) as a function of the electric current, respectively. It can be seen that NO conversion increases with the temperature and the electric current. Direct NO decomposition was observed without electrical field. With the increase in current, the NO conversion rate was significantly improved, suggesting a significant electrochemical promotion/reduction besides NO direct decomposition. Electrical field was essential for NiO-SSZ catalyst to have a high NC) conversion rate as shown in FIG. 5. However, with the increase in the electric current, the NO conversion rate tended to reach sonic limiting values. This suggests that the reaction might be controlled by the diffusion of NO, Pre-concentration of NO by using some adsorbents might be essential to improve the efficiency for NC) removal. The NO conversion rate at 700′C is higher than 600° C., demonstrating the potential application of the system at higher temperatures.

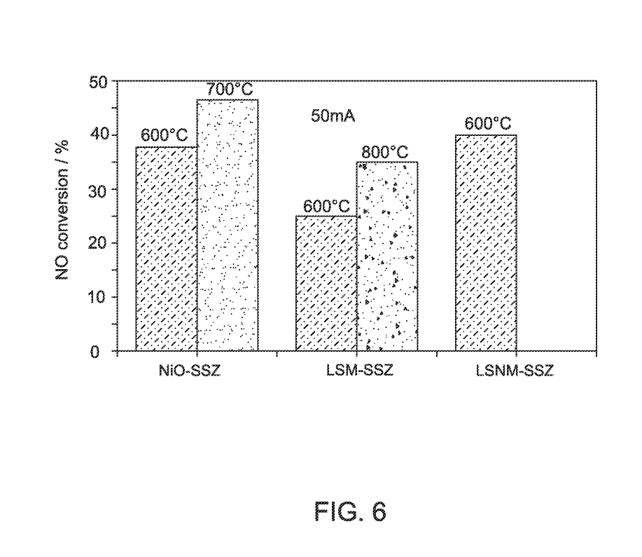

NO conversion rates of NO (80 ml/min 400 ppm NO balanced with He) under 50 ml at some typical temperatures in reactors using NiO-SSZ, LSM-SSZ, and LSNM-SSZ as cathode layers are summarized in FIG. 6. All the reactors showed the activity for NO removal especially under higher temperatures. LSNM-SSZ and NiO-SSZ gave a NO conversion rate as high as about 40% at 600° C. and were better than LSM-SSI.

NO conversion rate as a function of the electric current on LSNM-SSZ was tested on 20 ppm NO, and 80% NC) conversion was achieved at 600° C., suggesting that the catalyst is more efficient for the removal of low concentration NO effluent. Significant NO conversion rate without the electric current was observed, suggesting that direct NO decomposition plays an important role in present electrochemical NO reduction process.

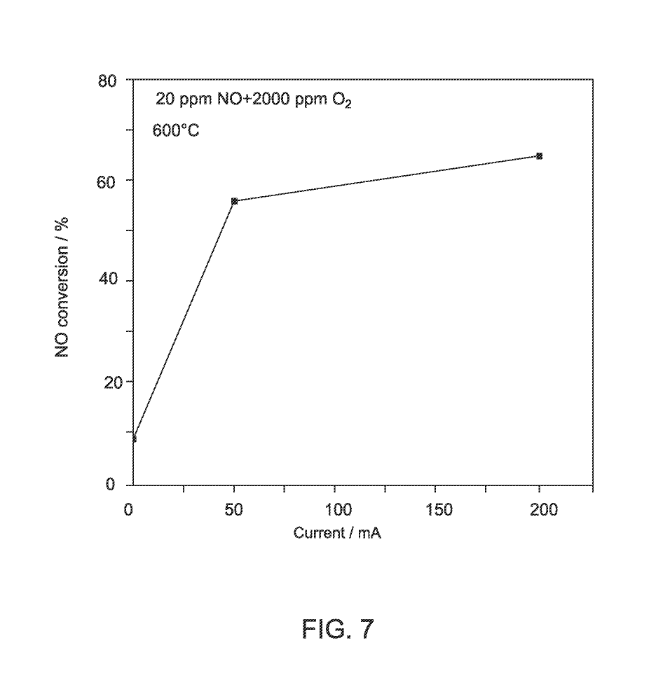

FIG. 7 illustrates NO conversion rate of 20 ppm NO+2000 ppm O₂ as a function of the electric current of the reactor using LSNM-SSZ as the cathode layer to show the effect of oxygen on NC) reduction. A surprising 60% NO conversion rate was obtained on the LSNM catalyst for the reactant containing 20 ppm NO and 2000 ppm 02, which was only slightly lower than that for the reactant without oxygen. It is an encouraging result since the concentration of O₂ is already 100 times higher than NO, demonstrating the potential to selectively reduce NO in the presence of O₂ in the real gas turbine case (15% O₂) after a careful design of the electrode composition and morphology. However, the NO conversion rate without the electric current for the reactant containing 2000 ppm oxygen seems much lower than that without oxygen, which means that only small part of NO is reduced by catalytic decomposition. NO₂ formation (2% and 6%) was observed on LSNM-SSZ without the DC current for treating 20 ppm NO and 20 ppm NO+2000 ppm O₂ balanced with He, which was due to the well-known NO decomposition and NO oxidation reaction at high temperature. NO₂ decreased to 0 and 4% at 50 mA for the two cases, respectively, demonstrating the NOx decomposition capability besides NO.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An apparatus comprising a first stack comprising:
a porous metallic current collector;
a first electrode layer on the porous metallic current collector;
a second electrode layer;
a first electrolyte layer between the first electrode layer and the second electrode layer;
a third electrode layer on the porous metallic current collector, the third electrode layer sandwiching the porous metallic current collector therebetween the first electrode layer;
a fourth electrode layer; and
a second electrolyte layer between the third and the fourth electrode layers.

2. The apparatus of claim 1, wherein the porous metallic current collector is in a form of mesh porous film, foam or any combination thereof.

3. The apparatus of claim 1, wherein the porous metallic current collector is a single layer.

4. The apparatus of claim 1, wherein the porous metallic current collector comprises more than one layer.

5. The apparatus of claim 1, wherein each of the first and the third electrode layers is an anode layer and each of the second and fourth electrode layers is a cathode layer.

6. The apparatus of claim 5, wherein the first stack comprises a blocking layer configured to block nitrogen oxide from entering the first and the third electrode layers and the first and the second electrolyte layers.

7. The apparatus of claim 1, wherein each of the first and third electrode layers is a cathode layer and each of the second and fourth electrode layers is an anode layer.

8. The apparatus of claim 7, wherein the first stack comprises a blocking layer to prevent nitrogen oxide from entering the second and the fourth electrode layers and the first and the second electrolyte layers.

9. The apparatus of claim 1, wherein a porosity of the porous metallic current collector is in a range from about 25% to about 99%.

10. The apparatus of claim 1, comprising a second stack sail:led to the first stack.

11. The apparatus us of claim 10, wherein the first and the second stacks are substantially identical.

12. The apparatus of claim 11, wherein the first and the second stacks connect at the second or the fourth electrode layers thereof.

13. A method comprising:
providing the apparatus of claim 1;
applying a first electric field between the first electrode layer and the second electrode layer;
applying a second electric field between the third and the our electrode layers; and
introducing nitrogen oxide to the apparatus to be decomposed into nitrogen and oxygen in the apparatus.

14. The method of claim 13, wherein each of the first and the third electrode layers is an anode layer and each of the second and fourth electrode layers is a cathode layer.

15. The method of claim 14, wherein the first stack comprises a blocking layer to prevent nitrogen oxide from entering the first and the third electrode layers and the first and the second electrolyte layers.

16. The method of claim 13, wherein each of the first and third electrode layers is a cathode layer and each of the second and fourth electrode layers is an anode layer.

17. The method of claim 16, wherein the first stack comprises a blocking layer to prevent nitrogen oxide from entering the second and the fourth electrode layers and the first and the second electrolyte layers.

18. The method of claim 13, wherein the apparatus comprises comprising a second stack stacked to the first stack.

19. The method of claim 18, wherein the first and the second stacks are substantially identical.

20. The method of claim 13, wherein a porosity of the porous metallic current collector is in a range from about 25% to about 99%.
